(19) United States
(12) Patent Application Publication
(10) Pub. No.: US 2006/0196236 A1
(43) Pub. Date: Sep. 7, 2006

(54) Lock with pivoting release

(76) Inventor: Frank Gruenendahl, Velbert (DE)

Correspondence Address: ST. ONGE STEWARD JOHNSTON & REENS, LLC, 986 BEDFORD STREET, STAMFORD, CT, 06905-5619, US

(21) Appl. No.: 11/339,200

(22) Filed: Jan. 25, 2006

(30) Foreign Application Priority Data
Jan. 25, 2005 (DE) 10-2005-003430.6
Dec. 5, 2005 (DE) 10-2005-057926.4

(51) Int. Cl. E05B 59/00; E05B 63/14

(52) U.S. Cl. 70/107

(57) ABSTRACT

The invention relates to a lock, particular an espagnolette, with bolt members that can be advanced by actuating a closing actuation element and with a means for preventing incorrect operation, which has a pivotable sensing element protruding through an opening in the lock case front, the advancing of the bolt members being blocked by a blocking member of the means for preventing incorrect operation when the sensing element is not pivoted and released when the sensing element is pivoted in one direction or the other. In order to develop a lock of the generic type in such a way that the means for preventing incorrect operation performs reliably both when there is a small rebate clearance and when there is a large rebate clearance it is suggested that the sensing element is mounted in a pivotally movable manner on a slide which can be displaced transversely in relation to the direction in which the lock case front extends, which slide has a release for the blocking member and can be displaced further inward beyond the pushed position reached with the respective pivoted end position of the sensing element.

### CROSS-REFERENCE TO RELATED APPLICATIONS

This application claims priority of German Patent Application No. 10-2005-003430.6 filed on Jan. 25, 2005 and German Patent Application No. 10-2005-057926.4 filed on Dec. 5, 2005.

### FIELD OF THE INVENTION

The invention relates to a lock, in particular an espagnolette, with bolt members that can be advanced by actuating a closing actuation element and with a means of preventing incorrect operation, which has a pivotable sensing element protruding through an opening in the lock case front, the advancing of the bolt members being blocked by a blocking member of the means for preventing incorrect operation when the sensing element is not pivoted and released when the sensing element is pivoted in one direction or the other. The invention additionally relates to a lock of this type and to a closure having at least one additional lock.

### BACKGROUND OF THE INVENTION

U.S. Pat. No. 6,393,878 B1 likewise discloses a lock of the generic type in which a means for preventing incorrect operation is provided. This is formed by a pivoting release, which has two sloping flanks running toward each other to a point. This ensures that the pivoting release can be used both in the case of doors hinged on the right and in the case of doors hinged on the left. The latch of this lock is configured in such a way that it has at its tail a quick-action closure, by which it is held in the housing. If need be, this quick-action closure can be detached, for example by means of a screwdriver, as a result of which it is then possible to pull it out of the latch, turn it through 180° about its own axis and reinsert it again. It is also ensured as a result that the lock can be used both for doors hinged on the left and doors hinged on the right.

A similar latch configuration is known from EP 1 482 110 A1. Here, the stop of the latch tail has to be brought out of the path of displacement of the latch. After that, the latch can be pulled out from the housing and the latch head can be turned through 180° in relation to the latch tail. After inserting the latch into the housing, the stop is brought back into the direction of movement of the latch tail and this prevents unwanted coming out of the latch.

A lock is also known from U.S. Pat. No. 5,820,177. In the case of such a lock, the means for preventing incorrect operation is formed by a slide. In order that the slide can be displaced inward with respect to the housing, it has a sloping flank. As soon as the slide moves against the striking plate, it is displaced inward with respect to the housing by means of the sloping flank. The sloping flank of the slide resembles the sloping flank of the latch. On the slide tail, it forms an angled portion, which protrudes into an opening in a blocking slide. The blocking slide is guided in the direction in which the lock case front extends. The opening has a drive slope. At the upper end, the blocking slide has a blocking catch, which interacts with blocking steps of a bolt tail. By actuating the slide, the drive slope is acted on, and the blocking catch leaves the blocking steps. Then, the bolt is displaced outward by a bolt spring. The blocking slide is acted on by a spring in such a way that it has the recurring tendency to engage with the blocking steps. The spring is formed as a torsion spring and also acts on the blocking slide. The latter is acted on in the direction in which the opening in the blocking slide extends.

EP 1 211 347 A1 describes a means for preventing incorrect operation in which a lug protruding into the rebate of the extruded section is provided, acting on a slide and the slide being displaced within the plane of the lock case front.

DE 695 10 412 T2 describes a means for preventing incorrect operation with a spring arm and a slide. In a non-actuated position of the means for preventing incorrect operation, the spring arm blocks the slide, which is mounted on the bolt actuating mechanism.

DE 102 09 574 A1 describes a blocking member for a driving rod, which interacts with a sensing element protruding from the lock case front. The sensing element is pivotally movable.

DE 101 42 470 C1 describes a means for preventing incorrect operation on an espagnolette fitting in which a spring element which is pivotable performs the blocking function.

DE 198 58 174 C2 describes a sensing element which is pivotable about a pivot axis running parallel to the lock case front. This sensing element is mounted on a slide. The slide can be pushed beyond a pushed position corresponding to the pivoted position of the sensing element into the lock case.

### SUMMARY OF THE INVENTION

It is an object of the invention to develop a lock of the generic type in such a way that the means for preventing incorrect operation performs reliably both when there is a small rebate clearance and when there is a large rebate clearance.

The object is achieved both by each individual claim on its own and by any combination of each claim with any other claim.

Claim 1 provides first and foremost that the sensing element is mounted in a pivotally movable manner on a slide which can be displaced transversely in relation to the direction in which the lock case front extends, which slide has a release for the blocking member and can be displaced further inward beyond the pushed position reached with the respective pivoted end position of the sensing element.

A lock of this type is preferably configured in such a way that it can be used for doors hinged on the left and doors hinged on the right. The sensing element has an axially symmetrical outline contour, with two sloping flanks running toward each other to a point.

In the pivoted position, one sloping flank of the sensing element lies against the edge of the opening and the other sloping flank of the sensing element acts like a latch slope, which interacts with a striking plate or the like. When the sensing element pivots, projections that extend from the base of the sloping flanks lie rearwardly against the lock case front. The slide can only be displaced inward with respect to the housing against the restoring force of a slide restoring spring. The slide forms a release for the blocking member. The release has the form of a cam. The blocking member is formed by an angular spring, which is engaged from underneath by the release. In the blocking position of the angular spring, its free end is in the path of movement of a driving-rod connecting slide, which is guided parallel to the lock case front. By actuating the sensing element, the slide is likewise displaced inward with respect to the housing and the angular spring is also lifted out of the path of movement of the driving-rod connecting slide. The slide lies in a guiding slot of the housing element and is guided transversely in relation to the direction in which the lock case front extends. Likewise disposed in the housing element is the angular spring, which forms the blocking member. The slide pushing-back spring lies in a depression. This depression is located in the base of the guiding slot of the housing element. The distance between the two sloping flanks of the sliding element at their base corresponds approximately to the clear width of the opening that is formed by the lock case front. This sensing element is mounted with an axis that lies in the axis of symmetry between two bearing legs of the slide. Such a lock is actuated by a closing actuation element. This is formed by a handle follower, in the square opening of which a handle grip can be inserted. Associated with the closing actuation element are additional locks, which are driven by the driving-rod connecting slide and the driving rods disposed on it. The entire assembly forms a closure.

The object stated at the beginning is additionally achieved by the characterizing features of Claim 7. There it is proposed that the blocking element can be displaced under cam control from a blocking position into a release position. The blocking element is held in the blocking position by a spring force. The displacement of the blocking leg of the blocking element takes place in the transverse direction in relation to the displacement of the slide. In a development of the invention, it is provided that the blocking element forms a rigid body. This rigid body can be mounted in a pivotally movable manner in the lock housing. For this purpose, the rigid body may form a bearing leg, which is supported for example on the base of the lock. The blocking member is pivoted about this bearing leg when it is driven by the cam. The drive preferably takes place by way of a sloping flank drive. For this purpose, the blocking member has a sloping flank. For this purpose, the control cam has a corresponding sloping flank. The two sloping flanks slide one on the other during the inward displacement of the sensing element. The sloping flanks therefore lie in contact against each other in the blocking position. The spring-loading of the blocking member may be provided by a separate spring. It may, however, also be brought about by appropriate resilience of the blocking element itself.

### BRIEF DESCRIPTION OF THE DRAWINGS

The invention described above is to be explained in more detail on the basis of exemplary embodiments. In the drawing:

FIG. 1 shows an espagnolette with multiple locking in the basic position,

FIG. 2 shows an espagnolette in which the additional locking mechanism is extended,

FIG. 3 shows an espagnolette in which the additional locking mechanism is extended and the bolt is advanced,

FIG. 4 shows an espagnolette in which the additional locking mechanism, the latch and the bolt are retracted,

FIG. 5 shows a perspective representation of the espagnolette without additional locking mechanisms,

FIG. 6 shows an enlargement of the espagnolette according to the position in FIG. 3 with a small rebate clearance, but here the housing cover is not represented,

FIG. 7 shows a representation similar to FIG. 6, but here there is a larger rebate clearance,

FIG. 8 shows a detail of the non-actuated means for preventing incorrect operation,

FIG. 9 shows a rear view of the means for preventing incorrect operation according to the position in FIG. 6,

FIG. 10 shows a rear view of the means for preventing incorrect operation according to the position in FIG. 7,

FIG. 11 shows a rear view of the means for preventing incorrect operation according to the position in FIG. 8,

FIG. 12 shows a perspective view of the slide and sensing element articulated on it,

FIG. 13 shows a section along the line XIII/XIII from FIG. 6,

FIG. 14 shows a section along the line XIV/XIV from FIG. 7,

FIG. 15 shows a section along the line XV/XV from FIG. 8,

FIG. 16 shows a second exemplary embodiment of the invention in a representation according to FIG. 6,

FIG. 17 shows an enlarged section along the line XVII-XVII in FIG. 16 in the blocking position of the lock,

FIG. 18 shows a representation according to FIG. 17 with the slide slightly displaced inward,

FIG. 19 shows a representation following on from FIG. 18, with the slide fully displaced inward,

FIG. 20 shows a greatly enlarged section along the line XX-XX in FIG. 16 in the blocking position of the lock,

FIG. 21 shows a representation corresponding to FIG. 20 in the release position of the lock,

FIG. 22 shows a perspective representation of the sensing element connected to the slide,

FIG. 23 shows a representation of the subject matter represented in FIG. 22 in side view,

FIG. 24 shows the two individual parts of the subject matter represented in FIG. 23,

FIG. 25 shows the sensing element in side view and, separately from it, the slide along a section taken along the line XXV-XXV in FIG. 24,

FIG. 26 shows a perspective representation of the sensing element,

FIG. 27 shows the rear view of the closure with the base of the lock removed, in a position of the blocking member that corresponds to FIG. 20, and

FIG. 28 shows a representation corresponding to FIG. 27 in an operating position according to FIG. 21.

### DETAILED DESCRIPTION OF THE INVENTION

In the case of such a lock 1, there is in question an espagnolette. The lock 1 is coupled by driving rods 2 in each case to an additional lock 3. The additional lock 3 has an additional bolt 4, which is mounted in the additional lock 3 in known manner.

The lock 1 substantially comprises a lock case front 5, a housing cover 6 and a housing base 7, which accommodate the internal components of the lock, a reversible latch 8, a bolt 9 and a means for preventing incorrect operation 10. The bolt 9 is advanced and retracted by a cylinder lock (not represented), which is actuated by a key or the like. The latch 8 is actuated in customary manner by a closing actuation element 11. This is formed by a handle follower 12 and has a square opening 13, which can accommodate a handle grip 14. A driving-rod connecting slide 15 can likewise be displaced by the closing actuation element 11.

The driving-rod connecting slide 15 is vertically guided by means of elongate holes 16, which extend in the direction in which the lock case front extends. Guiding pins 17, which protrude from the housing base 7, reach into the elongate holes 16. At the end, the driving-rod connecting slide 15 respectively forms a finger 18, which points in the direction of the lock case front 5. By means of this finger 18, the driving-rod connecting slide 15 is connected to the driving rods 2 in customary manner. The fingers 18 protrude into a recess or the like in the driving rods 2 and are in this way connected to it.

Approximately in the center of the lock 1 is the means for preventing incorrect operation 10. This substantially comprises a sensing element 19, which protrudes through a rectangular opening 20 in the lock case front 5, a slide 21, a blocking member 22, which is formed by an angular spring 46, and a housing element 23, which accommodates these elements. The sensing element 19 has an axially symmetrical outline contour, the sloping flanks 24 and 24′ of which run together to a point. At the base of the sloping flanks 24, 24′ of the sensing element 19, projections 25 extend on both sides in the transverse direction of the lock case front 5. The sensing element 19 forms an axis 26 lying in the axis of symmetry.

The slide 21 forms two bearing legs 27 in the manner of a fork. Disposed between the two bearing legs 27 is the sensing element 19. The axis 26 of the sensing element 19 in each case protrudes into an opening 28 in the bearing legs 27. As a result, the sensing element 19 is connected to the slide 21 in a pivotally movable manner. In FIG. 12 it is to be seen that the slide 21 forms a spike 29 at its rear end. This spike 29 serves for receiving a slide pushing-back spring 30. The slide 21 forms a release 31, which is formed by a cam 32. The cam 32 has a sloping face 33, which tapers inward with respect to the housing from the lock case front 5. The slide 21 lies in a guiding slot 34 of the housing element 23, which is securely screwed to the housing. In the guiding slot 34, the slide 21 is guided transversely in relation to the direction in which the lock case front extends. In FIG. 8 it is to be seen that the slide pushing-back spring 30 lies in a depression 35, which is formed by the base 36 of the slot 34. The other end of the slide pushing-back spring 30 is fitted on the spike 29 of the slide 21. In order that the slide 21 has only a specific moving path within the housing element 23, the housing element 23 forms stops 37. As is to be seen in FIG. 8, the stops 38 of slide 21 are pressed by the force of the slide pushing-back spring 30 against the stops 37 of the housing element 23.

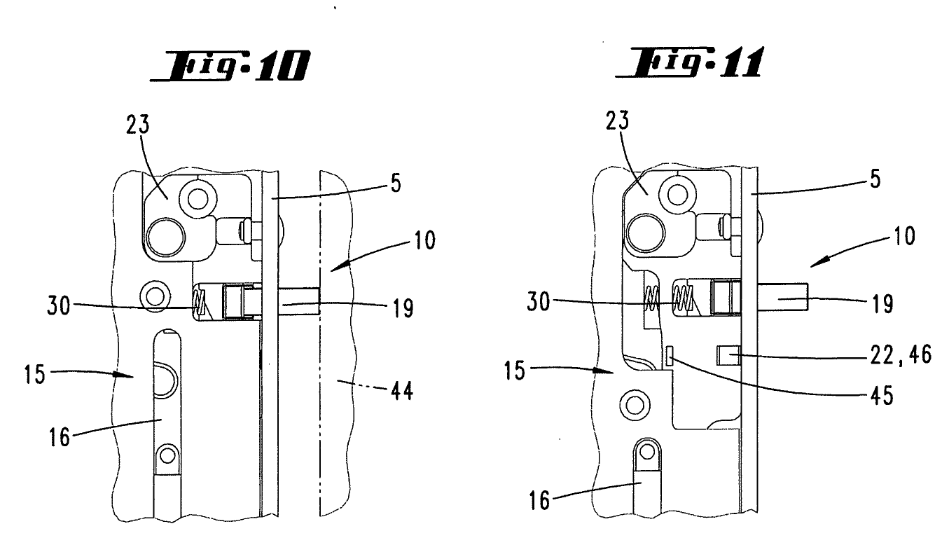

In FIGS. 13 to 15 it is to be seen how the blocking member 22 lies in the housing element 23. The blocking member 22 is configured as a U-shaped angular spring 46. In the U leg on the side on which the lock case front is situated, the blocking member 22 has a bore 39. Protruding into this bore 39 is a fixing portion 40 of the housing element 23. Underneath the bore 39, the housing element 23 forms a step 41. This region encloses an end portion of the leaf spring forming the blocking member 22. The U crosspiece 42 of the blocking member 22 engages over the release 31 of the slide 21. The other U leg of the blocking member 22, which runs parallel to the portion having the bore 39, lies in a slot 43. The free end 45 of the blocking member 22 lying in the slot 43 is bent over once for reasons of stability, thereby doubling the shearing-off resistance of the blocking member 22.

In the following part, the operating mode of the exemplary embodiment is described in more detail:

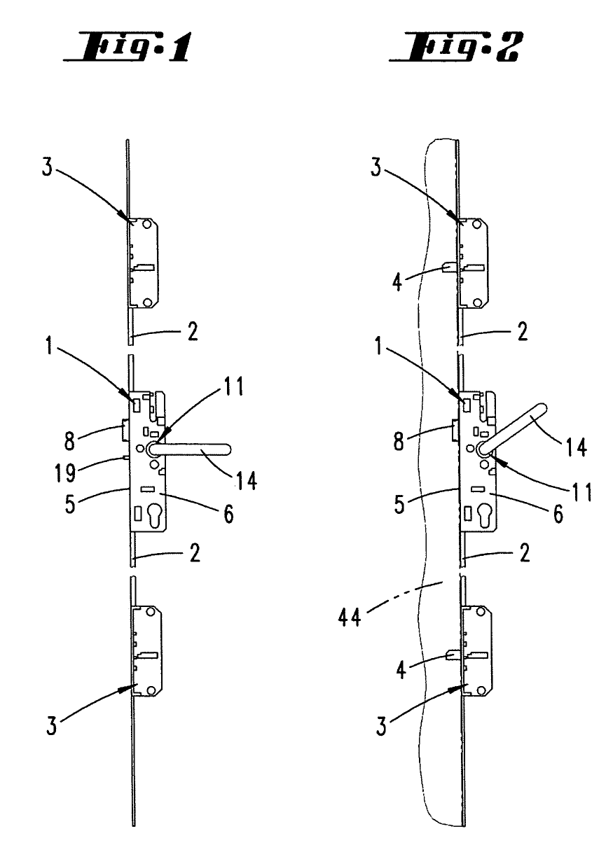

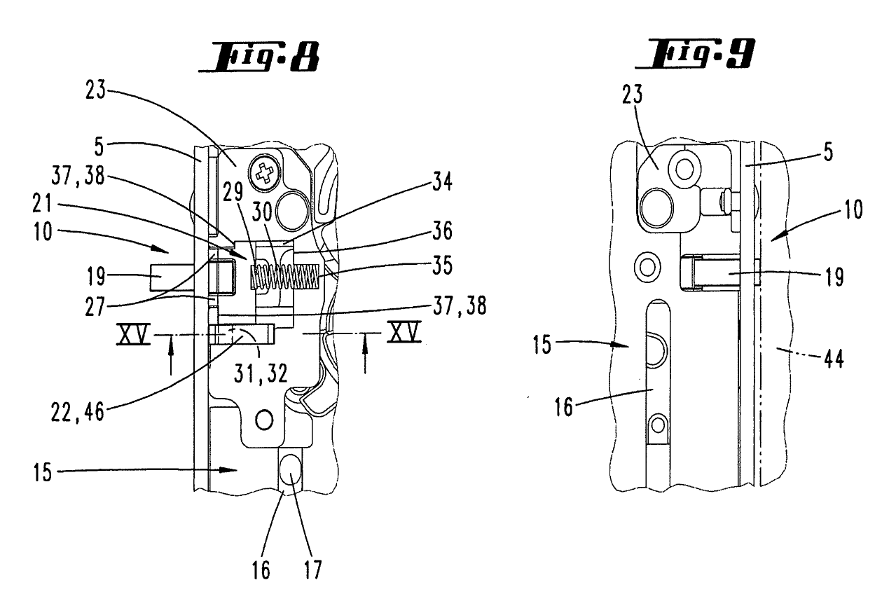

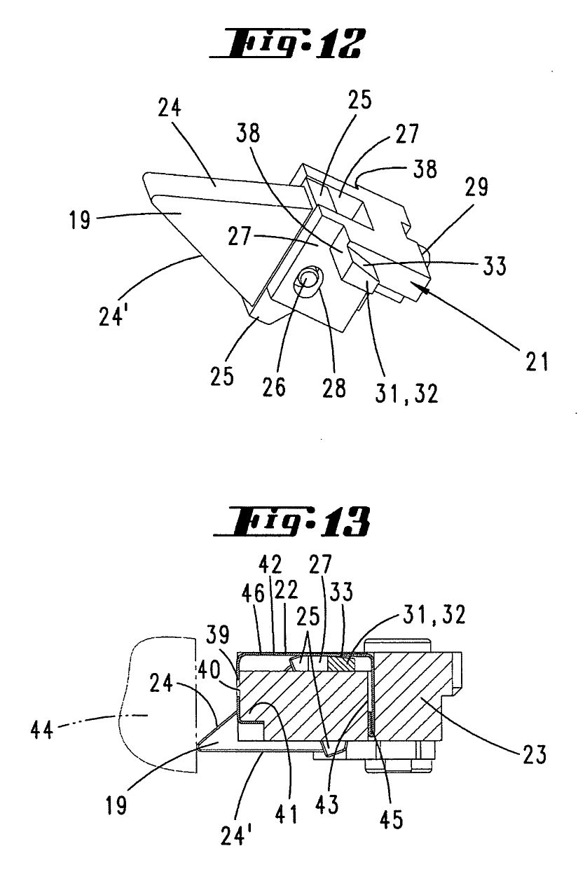

In FIG. 1, a lock 1 with additional locks 3 is represented. The left-right reversible latch 8 is in the advanced position and so is the sensing element 19 of the means for preventing incorrect operation 10. If the sensing element 19 is in this position, the closure cannot be locked by actuating the handle 14, since the free end 45 of the blocking member 22 is in the path of movement of the driving-rod connecting slide 15 (see FIGS. 11, 15). The handle 14, or the handle follower 11 accommodating the handle 14, is held in this position by a spring assembly in a neutral position. If, as in FIG. 2, the sensing element 19 is displaced inward with respect to the housing by a striking plate 44, the handle grip 14 can be pivoted approximately 45° counterclockwise. In this case, the additional bolts 4 of the additional locks 3 are extended. The handle follower 11 is displaced back into the middle neutral position by means of spring force. The handle follower 11 may also be pivoted in the opposite direction. This also takes place against the restoring force of the spring assembly. This serves for bolt or latch retraction.

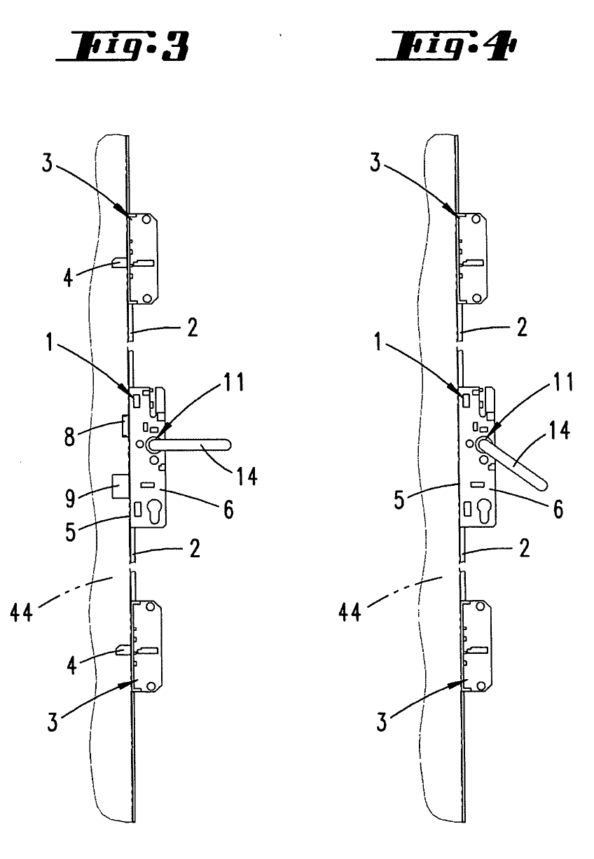

In FIG. 3, the bolt 9 has additionally been advanced by means of a locking cylinder (not represented). Here, too, the latch 8 engages in an engaging opening of the striking plate 44. In order then to open the door, as illustrated in FIG. 4, the bolt 9 must first be retracted by means of the locking cylinder, and the handle grip 14, which is in the starting position again, must be displaced through approximately 45° clockwise. As a result, the additional bolts 4 of the additional locks 3 and the catch 8 are displaced inward with respect to the housing, out of the engagement opening of the striking plate 44.

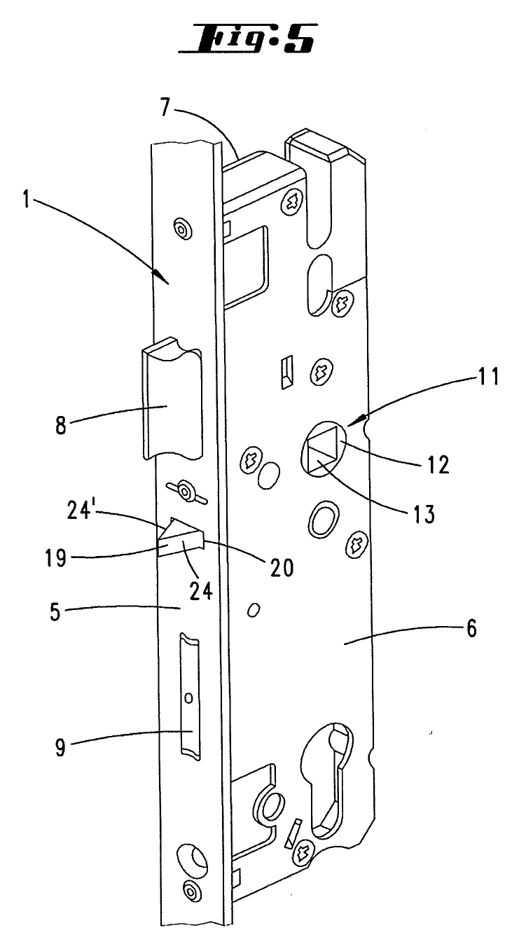

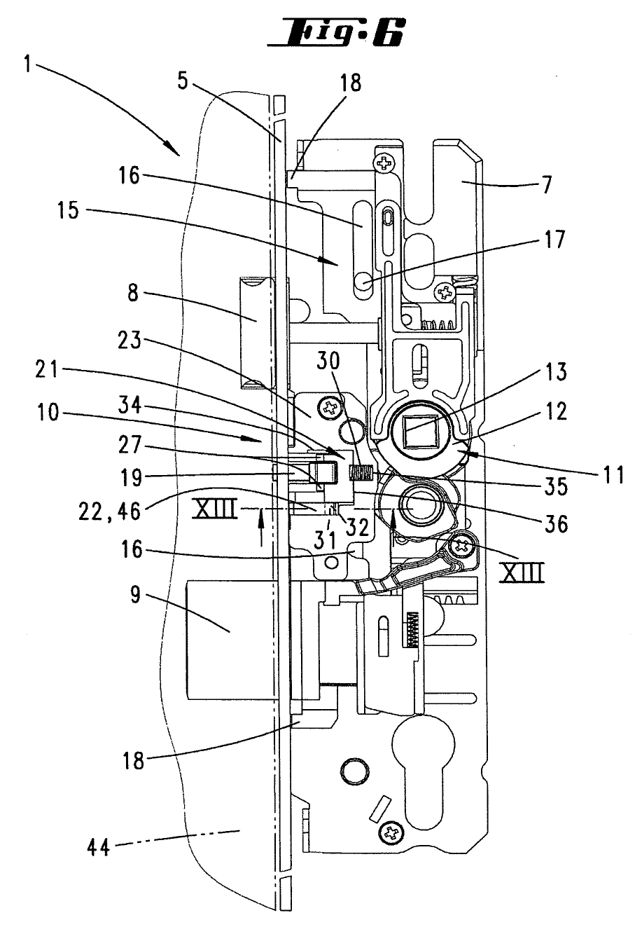

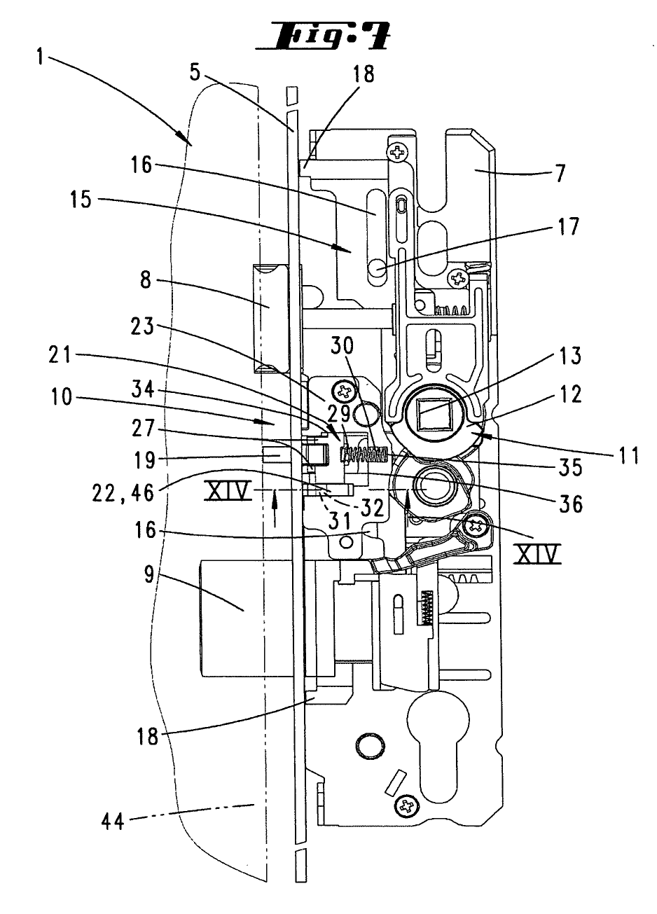

It is explained in more detail on the basis of the figures that follow how the means for preventing incorrect operation 10 operates. In FIG. 5, the lock 1 is in the starting position. Here it is seen how the sensing element 19 protrudes approximately 10 mm out of the opening 20 in the lock case front 5. In this position, the projections 25 lie against the rear side of the lock case front. In FIG. 6, the lock 1 is represented with an interacting striking plate 44. Here there is a rebate clearance of approximately 2 mm. The striking plate 44 has caused the sensing element 19 to be displaced together with the slide 21 inward with respect to the housing against the force of the slide pushing-back spring 30. When the door is swung closed, a sloping flank 24, 24′ of the sensing element 19 comes up against an edge of a striking plate 44. The further swinging-closed movement of the door is accompanied by the sensing element 19 being pivoted about the axis 26, the edge of the striking plate 44 sliding along on the sloping flank 24, 24′ facing it. As a result of the symmetrical shape and mounting of the sensing element 19, this can take place on doors hinged on the left and doors hinged on the right. The sensing element 19 is pivoted until the sloping flank 24′ rests on the edge of the opening 20. In this case, the sensing element 19 pivots in each case about a projection 25. Now the projection 25 of the sensing element 19 is supported on the rear side of the lock case front 5. The other sloping flank 24 now acts like a latch slope. When the striking plate 44 runs up further onto the sloping flank 24 of the sensing element 19, the sensing element 19 is displaced together with the slide 21 inward with respect to the housing. The blocking member 22 was already released when the pivoted end position of the sensing element 19 was reached. The free end 45 of the U-shaped leaf spring 22 has left the path of movement of the driving-rod connecting slide 15. As is to be seen in FIG. 9, the driving-rod connecting slide 15 can be displaced upward with respect to the operating position represented in FIG. 11. FIG. 13 illustrates how the release 31 has displaced the blocking member 22 out of the displacement path of the driving-rod connecting slide 15. In FIGS. 7, 10 and 14, the interaction of the means for preventing incorrect operation 10 with a larger rebate clearance of approximately 6 mm is represented. In FIG. 14 it is to be seen that the small moving path of the sensing element 19 and of the slide 21 inward with respect to the housing into the pivoted end position of the sensing element 19 is adequate to displace the blocking member 22 out of the path of movement of the driving-rod connecting slide 15. In FIGS. 8, 11 and 15, the means for preventing incorrect operation 10 is represented in the non-actuated state. In FIG. 11 it is to be seen how the free end 45 protrudes into the path of movement of the driving-rod connecting slide 15. This can also likewise be seen in FIG. 15.

In the case of a small rebate clearance (approximately 2 mm), the sensing element 19 can be displaced almost fully inward with respect to the lock. In the case of a large rebate clearance (approximately 6 mm), the means for preventing incorrect operation 10 is released when a pivoted end position of the sensing element 19 is reached.

The slide 21 may be of different lengths, to allow compensation for the different lengths of the different spike sizes. When the door is open, the means for preventing incorrect operation 10 prevents the additional locks 3 from being actuated by the driving-rod connecting slide 15 with the aid of the closing actuation element 11, so that the additional bolts 4 extend. If it were then desired to close the door, the additional bolts 4 of the additional locks 3 would come up against the striking plate 44. It is consequently not possible for the door to be closed. To be able to close the door again, the additional bolts 4 must be brought back into their retracted position with the aid of the closing actuation element 11. As a result, the driving-rod connecting slide 15 is displaced and the free end 45 of the blocking member 22 can then spring back again into the path of movement of the driving-rod connecting slide 15. The starting position of the means for preventing incorrect operation 10 is restored.

It would also be conceivable, as described in the prior art, to form the latch in such a way that it can be used both for doors hinged on the left and for doors hinged on the right. For this purpose, the latch may, for example, have on its latch tail a quick-action closure, with which the latch can be removed from the housing, turned through 180° and then inserted again. It would, however, also be conceivable to solve the problem with a pivotable latch head.

The aforementioned additional locks 3 may take any form desired. Quite generally, they may be additional locking mechanisms driven by driving rods 2. The bolt members may be pivoting bolts or push bolts. They may, however, also be rolling or mushroom-headed pins, which are secured on the driving rods. The bolt members, in particular the rolling or mushroom-headed pins, may, however, also be associated with angle brackets or right-angle gear mechanisms.

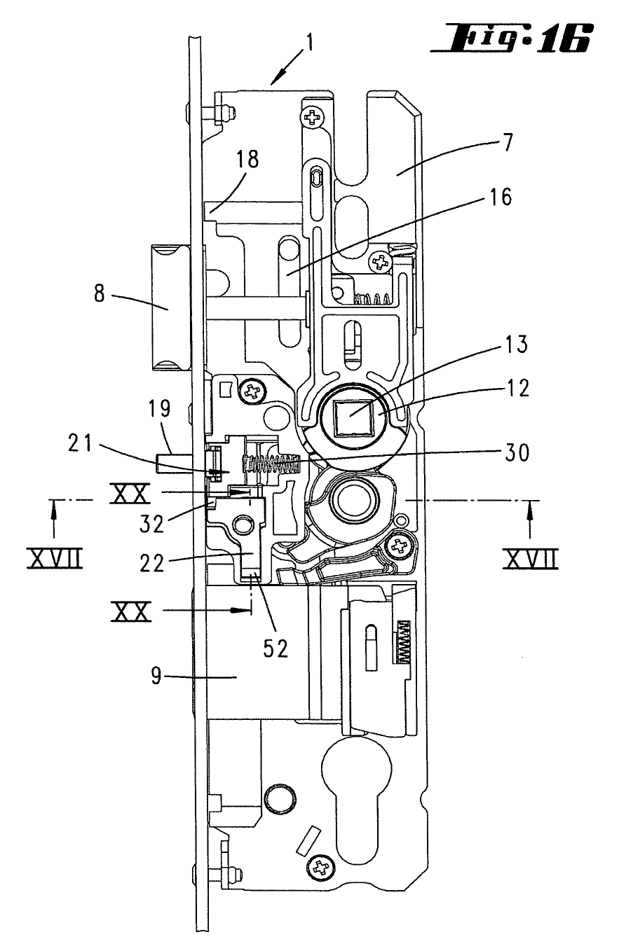

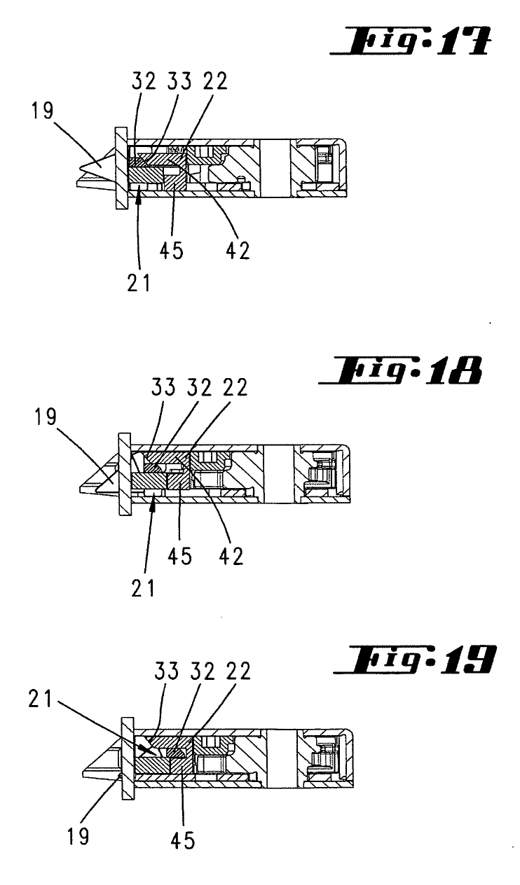

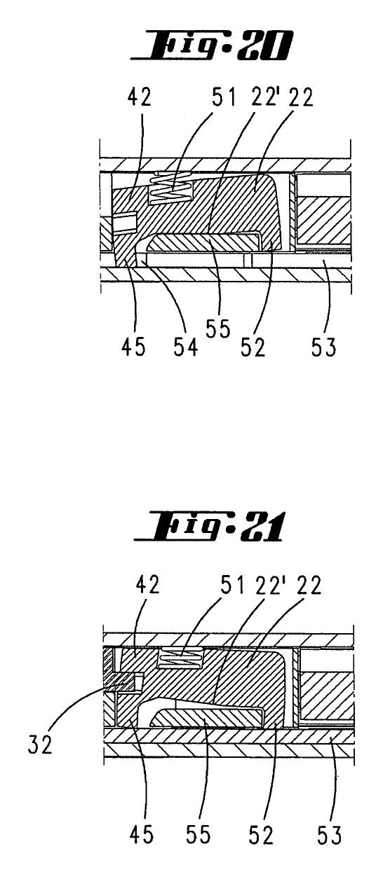

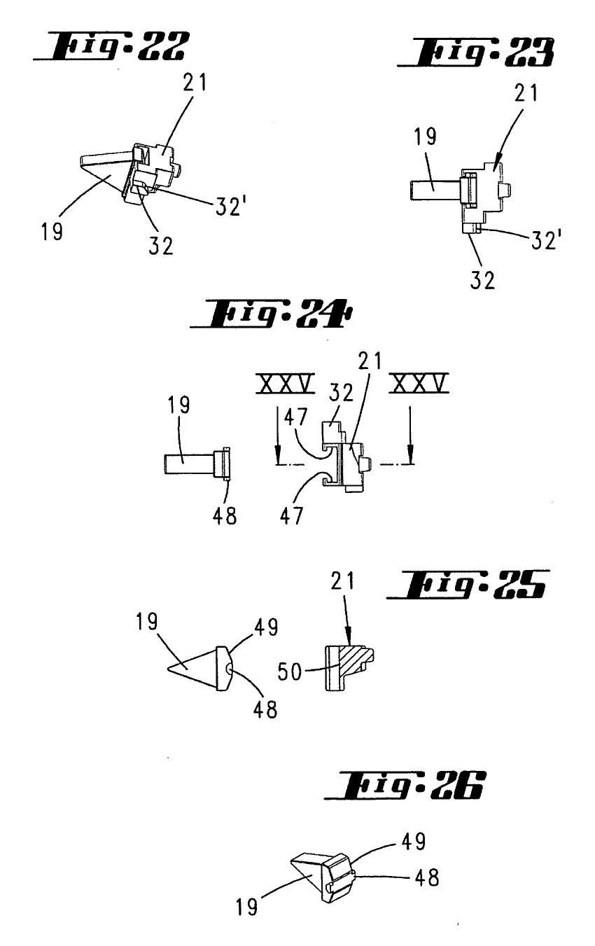

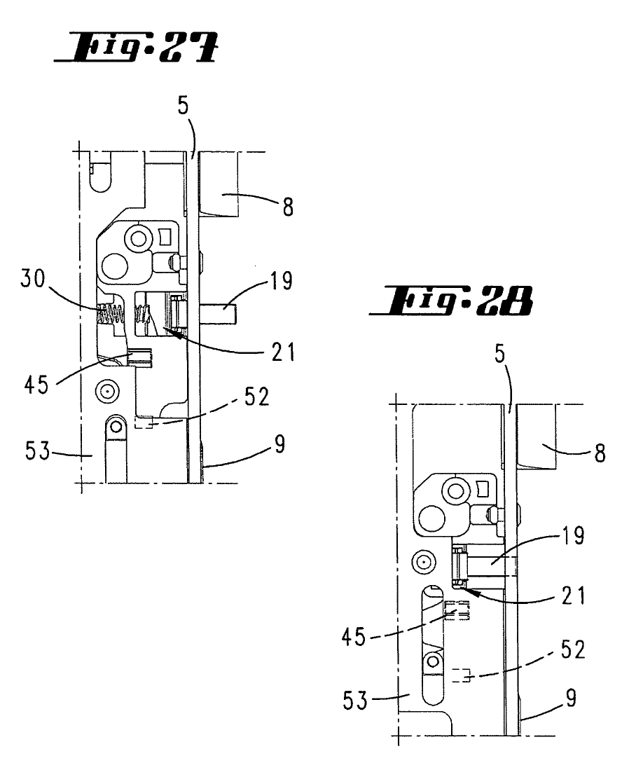

In the case of the second exemplary embodiment, represented in FIGS. 16 to 26, the sensing element 19, the slide 21 and the blocking member 22 have been structurally modified in comparison with the first exemplary embodiment (FIGS. 1 to 15). The sensing element 19 now lies in a C-shaped recess in the slide 21. The sensing element forms two bearing pins 48, which are located opposite one another and lie in bearing grooves 47 of the slide 21. The bearing grooves 47 are in this case formed by the C-shaped groove. The base 50 of the C-shaped groove forms a supporting surface. The rear 49 of the sensing element 19 is supported against the supporting surface 50. If the sensing element is pivoted in the manner described with respect to the first exemplary embodiment, the rounded rear 49 can be supported on the supporting surface 50. The rear 49 does not necessarily have to have a curved surface. It may also—as in the case of the exemplary embodiment—be curved with a polygonal contour.

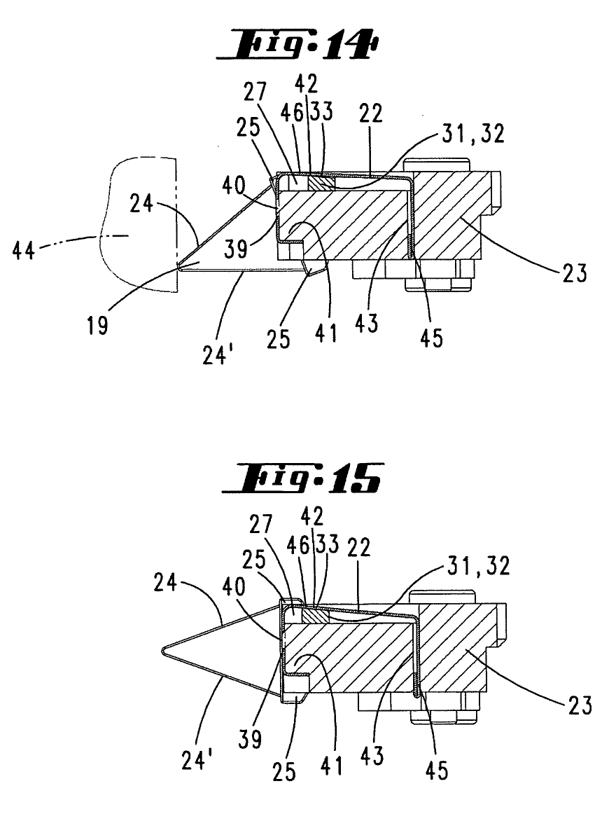

The slide 21 has a laterally protruding cam 32. This cam 32 has a sloping flank 32′, which corresponds to a sloping flank 33 of the blocking member 22. In the blocking position represented in FIG. 17, a sloping flank 32′ of the cam 32 lies in surface contact with the sloping flank 33 of the blocking member 22. This sloping flank 33 is formed by the end face of a horizontal portion 42 of the blocking member 22.

At the end of the blocking member 22 that is opposite from the sloping flank 33, there protrudes a blocking leg 45. In the blocking position, this blocking leg 45 is supported on the lock base of the lock 1.

The blocking member 22 is pivotably mounted in the lock housing 1. The blocking member 22 may perform a pivoting movement about a bearing leg 52, which bearing leg 52 protrudes at right angles from the horizontal portion 42 of the blocking member 22. The bearing leg 52 extends approximately parallel to the blocking leg 45, but is spaced apart from the latter. In the region between the bearing leg 52 and the blocking leg 45 there is, on the other side of the horizontally running portion 42 of the blocking member 22, a hollow. Located in this hollow is a compression spring 51, which is supported on the lock cover. With this compression spring 51, the blocking member 22 is held in the blocking position.

The bearing leg 52 may be supported on the lock base or at some other suitable location that is fixed to the housing. In the case of the exemplary embodiment, the bearing leg 52 is supported on a driving-rod connecting slide 53 when the locking leg 45 assumes its release position. Otherwise, a portion 22′ of the blocking member 22 that is located between the bearing leg 52 and the blocking leg 45 may be supported on a housing part 55. The portion 22′ runs in the plane in which the blocking member 22 extends.

If the slide 21 is displaced from the blocking position, represented in FIG. 17, into the position represented in FIG. 18, the sloping flank 33 of the blocking member slides on the sloping flank 32′ of the cam 32. As a result, the blocking member 22 pivots about the bearing point of the bearing leg 52. The bearing leg 45 is raised in the transverse direction in relation to the direction of displacement of the slide 21 and leaves the blocking-leg entry opening 54, having a blocking shoulder, of a driving-rod connecting slide 53, which is guided on the lock base and which serves for driving the bolt elements 4. The driving-rod connecting slide 53 consequently forms an actuating slide which is prevented from actuation by the means for preventing incorrect operation.

Assembly of the elements of the lock represented in FIGS. 22 to 26 is effected by inserting the bearing pins 48 into the bearing grooves 47. While the blocking member 22 of the second exemplary embodiment is preferably formed by a rigid metal part, the sensing element 19 and the slide 21 may be produced from plastic. It is also possible, however, to produce the blocking member 22 from a suitable, solid plastic. As can be gathered from FIG. 16, the bearing leg 52 is formed by an arm of the blocking member 22 that extends at right angles in relation to the direction of displacement of the slide 21.

All features disclosed are (in themselves) pertinent to the invention. The disclosure content of the associated/attached priority documents (copy of the prior patent application) is also hereby incorporated in full in the disclosure of the application, including for the purpose of incorporating features of these documents in claims of the present application.

1. Lock, in particular an espagnolette, with bolt members that can be advanced by actuating a closing actuation element and with a means for preventing incorrect operation, which has a pivotable sensing element protruding through an opening in the lock case front, the advancing of the bolt members being blocked by a blocking member of the means for preventing incorrect operation when the sensing element is not pivoted and released when the sensing element is pivoted in one direction or the other, characterized in that the sensing element is mounted in a pivotally movable manner on a slide which can be displaced transversely in relation to the direction in which the lock case front extends, which slide has a release for the blocking member and can be displaced further inward beyond the pushed position reached with the respective pivoted end position of the sensing element.

2. Lock according to claim 1, characterized in that the sensing element has an axially symmetrical outline contour, with sloping flanks running toward each other to a point.

3. Lock according to claim 1, characterized in that, in the pivoted end position, one sloping flank of the sensing element lies against the edge of the opening and the other sloping flank of the sensing element forms a latch slope for a striking plate or the like.

4. Lock according to claim 1, characterized in that associated with the base of the sloping flanks of the sensing element are projections which lie rearwardly against the lock case front and are supported on the rear side of the lock case front during the pivoting of the sensing element.

5. Lock according to claim 1, characterized in that the slide can be displaced inward with respect to the housing lock against the restoring force of a slide restoring spring.

6. Lock according to claim 1, characterized in that the release is a cam formed on the slide.

7. Lock, in particular an espagnolette, with bolt members that can be advanced by actuating a closing actuation element and with a means of preventing incorrect operation, which has a pivotable sensing element protruding through an opening in the lock case front, the advancing of the bolt members being blocked by a blocking member of the means for preventing incorrect operation when the sensing element is not displaced in the direction of the lock case front and released when the sensing element is displaced in the direction of the lock case front, characterized by a control cam, which is displaced along with the sensing element and runs under a control leg of a blocking member, which blocking member forms a blocking leg protruding at right angles, which in the blocking position lies in front of a blocking shoulder of a bolt actuating slide guided in the lock housing and in the release position is brought away from the blocking shoulder, under the control of the cam and against the force of a restoring spring.

8. Lock according to claim 7, characterized in that the blocking member is an angular spring, which is engaged from underneath by the release.

9. Lock according to claim 7, characterized in that, in the blocking position, the free end of the angular spring is in the path of movement of a driving-rod connecting slide, which is guided parallel to the lock case front, and by displacing the slide from the blocking position of the slide, from the release into the pivoted end position of the sensing element, is lifted out of the path of movement.

10. Lock according to claim 7, characterized in that the slide is guided in a housing element, forming a guiding slot, transversely in relation to the direction in which the lock case front extends.

11. Lock according to claim 7, characterized in that the blocking member is associated with the housing element.

12. Lock according to claim 7, characterized in that the slide pushing-back spring is supported in a depression, which is associated with the base of the guiding slot of the housing element.

13. Lock according to claim 7, characterized in that the distance between the two sloping flanks at their base corresponds approximately to the clear width of the opening.

14. Lock according to claim 7, characterized in that the sensing element is mounted with an axis that lies in the axis of symmetry between two bearing legs of the slide.

15. Lock according to claim 7, characterized in that the closing actuation element is a handle follower, in the square opening of which a handle grip can be inserted.

16. Lock according to claim 7, characterized in that the bolt members that can be displaced by the closing actuation element are associated with additional locking mechanisms such as additional locks, which can be driven by means of the driving-rod connecting slide, by driving rods.

17. Espagnolette with a lock, in particular according to claim 7, and at least one additional lock, characterized in that the additional locking means have rolling or mushroom-headed pins or pushing or pivoting bolts.

18. Espagnolette with a lock, according to claim 7, and at least one additional locking mechanism.

19. Lock according to claim 7, characterized in that the blocking member is a rigid body mounted in a pivotally movable manner in the housing.

20. Lock according to claim 7, characterized in that the blocking member is supported on a housing side wall by a compression spring.

21. Lock according to claim 7, characterized in that the blocking member forms a bearing leg, which supports the blocking member fixedly on the housing.
